(19) United States
(12) Patent Application Publication
(10) Pub. No.: US 2012/0084707 A1
(43) Pub. Date: Apr. 5, 2012

(54) SYSTEM AND METHOD FOR CONTROLLING EVENT NOTIFICATIONS

(75) Inventors: Sherif Aly Abdel-Kader, Waterloo (CA); Leonid Vymenets, North York (CA); Munish Taneja, Toronto (CA)

(73) Assignee: Research in Motion Limited, Waterloo (CA)

(21) Appl. No.: 12/894,972

(22) Filed: Sep. 30, 2010

(51) Int. Cl. G06F 3/048

(52) U.S. Cl. 715/779

(57) ABSTRACT

A system and method are provided that use visually distinguishable identifiers already associated with particular contacts or groups of contacts to selectively associate a particular contact or group with event notifications displayed in the ribbon. In this way, the user can, at a glance, not only be notified of a new event, but also determine the origin of the event notification to provide better context for determining whether or not they wish to access and view the new event or update or whether this can be deferred.

### TECHNICAL FIELD

The following relates to systems and method for controlling event notifications.

### BACKGROUND

Mobile communication devices are often used to communicate via several different media. For example, a smart phone or personal digital assistant (PDA) having wireless communication capabilities may be used to participate in cellular telephone conversations, to exchange email, to exchange SMS or multimedia messaging service (MMS) messages, to participate in instant messaging (IM) or other conversational type message exchanges, to post or receive social networking updates, etc.

Often new incoming messages, updates, or other events are notified to the user in a banner or ribbon, typically in an uppermost portion of the display. The ribbon also enables other general information such as the date, time, battery life, and service provider/coverage information among others. Therefore, the ribbon is often used as a quick-reference area on the display.

### BRIEF DESCRIPTION OF THE DRAWINGS

Embodiments will now be described by way of example only with reference to the appended drawings wherein:

FIG. 1 is a block diagram showing an example communications system.

FIG. 2 is a block diagram showing an example configuration for the mobile device of FIG. 1.

FIG. 3 is a system diagram showing one configuration for exchanging IMs on multiple platforms.

FIG. 4 is an external view of an example mobile device.

FIG. 5 is an example screen shot of a display screen comprising a ribbon.

FIG. 6 is a screen shot of the display screen of FIG. 5 showing a particular icon being highlighted and menu displayed.

FIG. 7 is a screen shot of a ribbon notifications customization interface.

FIG. 8 is a screen shot of the display screen of FIG. 5 showing another particular icon being highlighted and selected.

FIG. 9 is a screen shot of a contact list interface.

FIG. 10 is a screen shot of the display screen of FIG. 5 showing another particular icon being highlighted and selected.

FIG. 11 is a screen shot of a conversation interface.

FIG. 12 is a flow chart illustrating example computer executable instructions for controlling the display of icons in the ribbon.

FIG. 13 is a flow chart illustrating example computer executable instructions for utilizing the menu shown in FIG. 6.

FIG. 14 is a flow chart illustrating example computer executable instructions for accessing an interface associated with an event by selecting an icon from the ribbon.

FIG. 15 is a block diagram of an exemplary embodiment of a mobile device.

### DETAILED DESCRIPTION OF THE DRAWINGS

Although typical event notifications displayed on the ribbon of a mobile device provide, at a glance, the existence of new, unread or otherwise unacknowledged events, such event notifications are often generic and still require the user to access the corresponding program in order to determine what or who the notification relates to. Consequently, the user may find that the event notifications are distracting and cause unnecessary switching between applications in order to find out if an incoming event is important or corresponds to a particular sender/originator.

In order to address these potential drawbacks, visually distinguishable identifiers that are already associated with particular contacts can be selectively associated with event notifications displayed in the ribbon. In this way, the user can, at a glance, not only be notified of a new event, but also determine the origin of the event notification, to provide better context for determining whether or not they wish to access and view the new event or update or whether this can be deferred. In the following, a “contact” may refer to a device associated with an individual user or entity, an electronic group of entities or users, or any other entity that can be represented by a contact list entry.

The visually distinguishable identifiers, in some embodiments, comprise avatars, icons, logos or other graphical representations of the particular contacts or groups. In order to manage the typically limited space afforded to the display ribbon, as will be explained in greater detail below, specific contacts can be selected, the total number of identifiers can be selected, priorities can be set for different contacts, and the number of personal versus group identifiers can be selected. By providing flexible options, a user can have preferred contacts or event types given priority over those that are not as important. Moreover, by enabling control over the number and type of identifiers displayed at any given time, unnecessary and undesired clutter of the ribbon can be avoided.

Although the following examples are presented in the context of mobile communication devices, the principles may equally be applied to other devices such as applications running on personal computers and the like.

For clarity in the discussion below, mobile communication devices are commonly referred to as “mobile devices” for brevity. Examples of applicable mobile devices include without limitation, cellular phones, cellular smart-phones, wireless organizers, pagers, personal digital assistants, computers, laptops, handheld wireless communication devices, wirelessly enabled notebook computers, portable gaming devices, tablet computers, or any other portable electronic device with processing and communication capabilities.

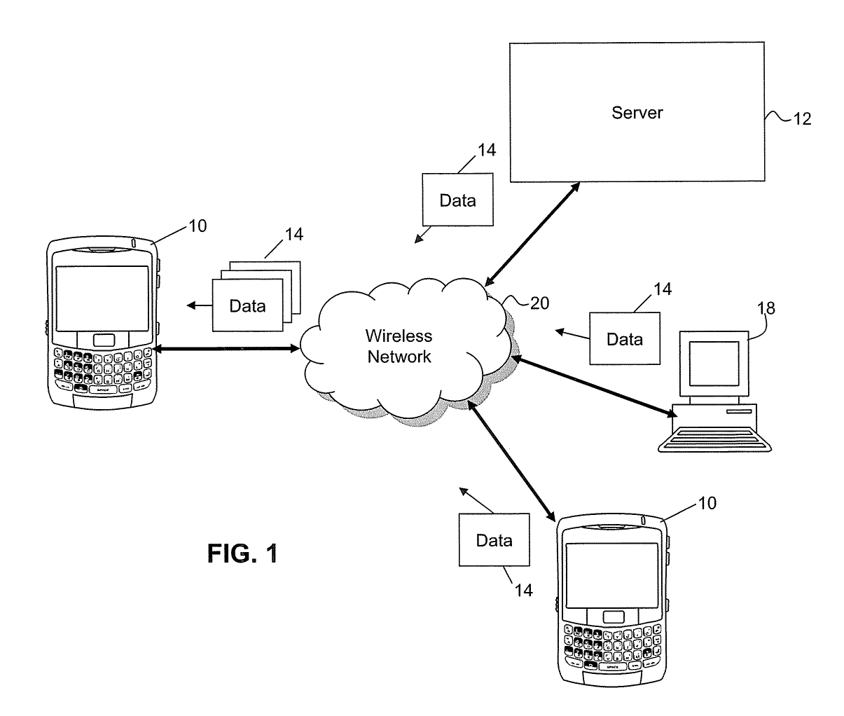

FIG. 1 illustrates an example communications system wherein a first mobile device 10 receives or otherwise obtains various data 14 via a wireless network 20. The data 14 may represent electronic messages (e.g. email, SMS, MMS, IM, etc.), calendar appointments, multimedia, voice communications, etc., to name a few. The data 14 may originate from various types of devices such as a server 12, a desktop computer 18, and other mobile devices 10 as shown by way of example only in FIG. 1.

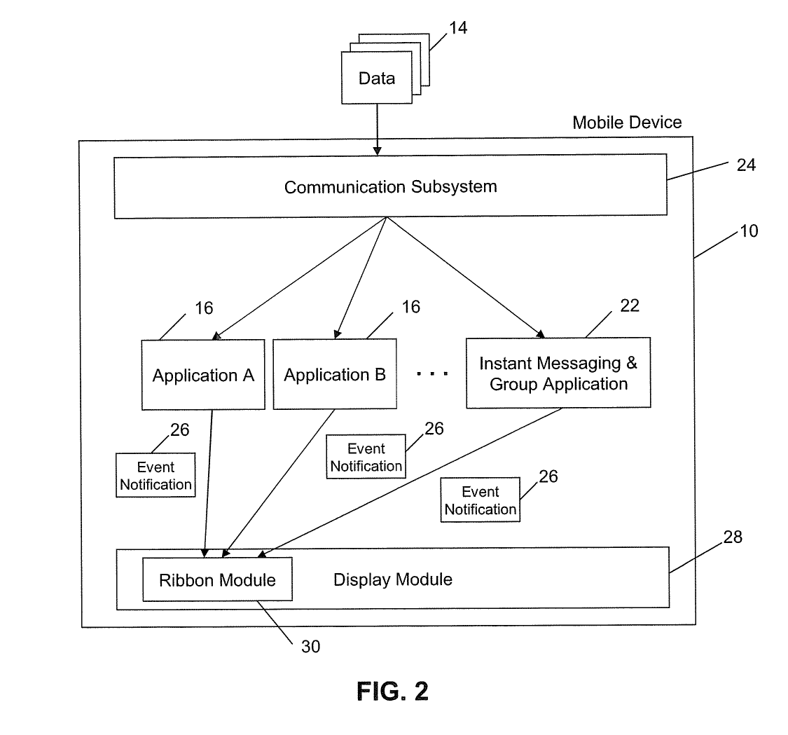

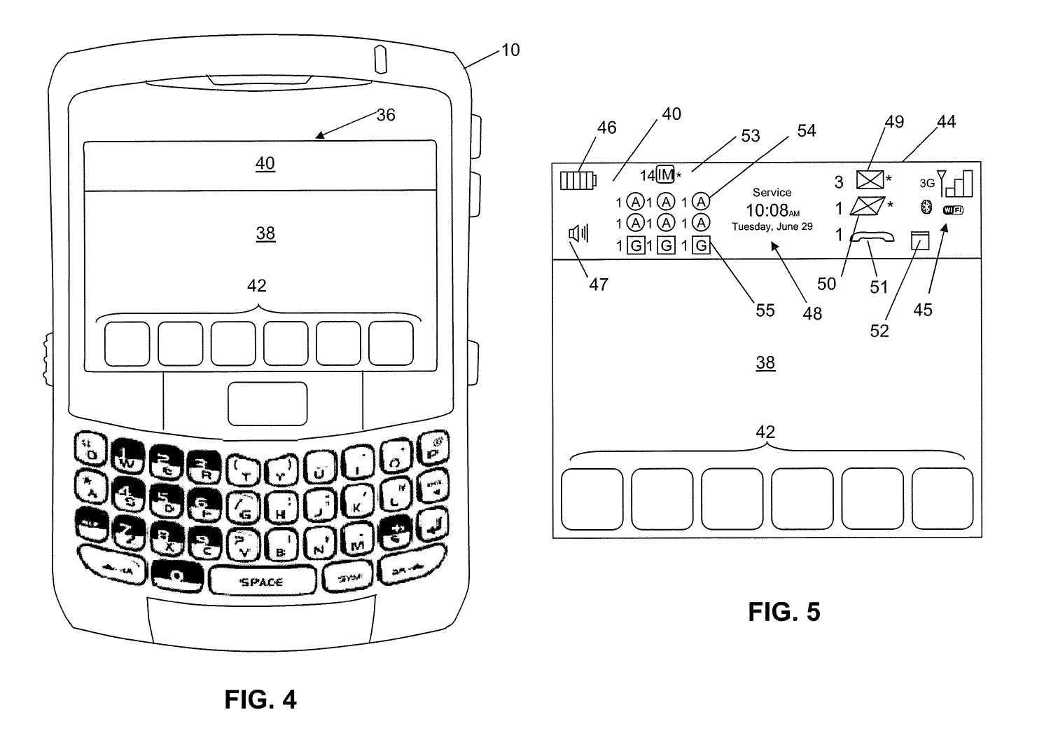

Turning now to FIG. 2, an example configuration for the mobile device 10 receiving data 14 is shown. It will be appreciated that the mobile device 10 may be configured in a different way and may comprise additional components to those shown in FIG. 2 while enabling the principles discussed herein to be implemented. In this example, a communication subsystem 24 is provided which enables the mobile device 10 to communicate via the wireless network 20, including for obtaining or receiving data 14. The data 14, as discussed earlier, may correspond to various different communications media and thus such data 14 is typically received and handled by a corresponding application 16. Of the applications 16 illustrated in FIG. 2, an instant messaging and group application 22 is shown which may hereinafter be referred to as “the IM application 22” for brevity. In many circumstances, the arrival of new data 14 may be considered an event that is notified to the user via an event notification 26 which is displayed on a display screen 38 (see also FIG. 4) using a display module 28. As shown in FIG. 2, in this example, the display module 28 includes a ribbon module 30 which corresponds to a particular portion of the display screen commonly known as the ribbon 40 (see also FIG. 4). The ribbon 40 may comprise any particular portion of the display screen 38 but is often an upper portion of the display screen 38 as shown in FIG. 4. It can be appreciated that the ribbon module 30 and display module 28 are shown as such in FIG. 2 for illustrative purposes only. For example, the ribbon module 30 may form an integral portion of the display module 28 or may be an entirely separate and distinct module which is communicatively connectable to the display module 28.

The event notifications 26 are used to display visual identifiers in the ribbon 40 in order to provide the user at a brief glance, general information about the existence of new events. Often the ribbon 40 or a modified version thereof is kept on the display screen 28 in multiple views and in conjunction with other applications also being displayed on the display screen 38. Therefore, the ribbon 40 may be relied on in various situations to provide updates regarding newly detected events.

Further detail of the way in which the IM application 22 is used for conducting instant messaging will now be described by way of example only.

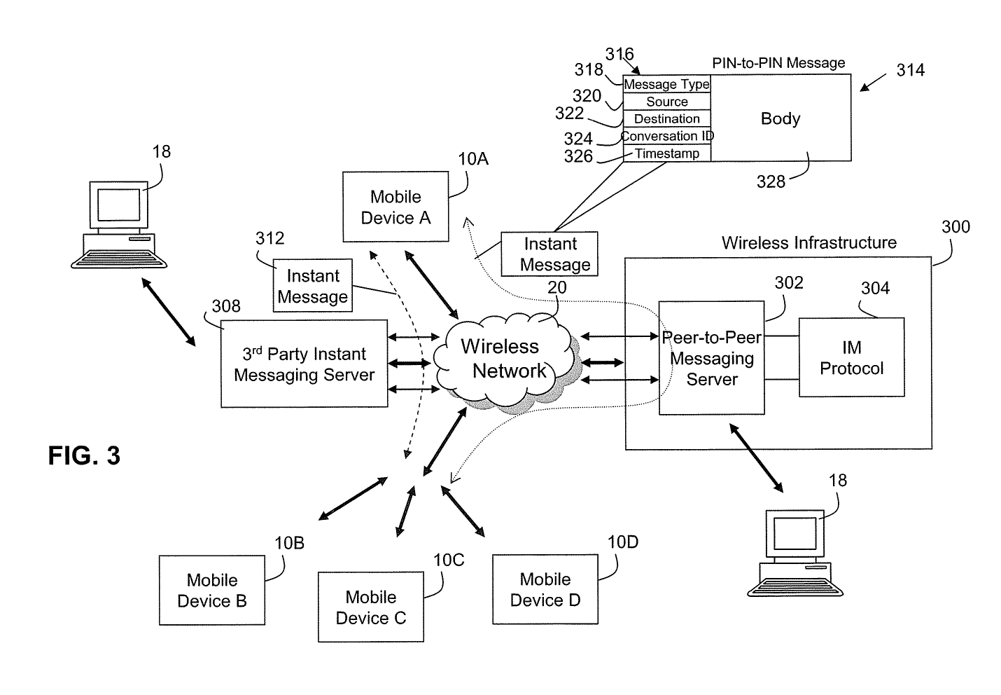

Turning now to FIG. 3, a configuration suitable for a user of mobile device A, hereafter referred to as mobile device 10A, to conduct instant messaging with buddies included in their IM contact list 18 is shown. It can be seen in FIG. 3 that two examples of instant messaging systems are shown. A first system incorporated into the wireless infrastructure 300 of a wireless network 20 is shown, which in this example is a peer-to-peer based system, e.g. a personal identification number (PIN)-based messaging system, that utilizes a device such as a server or router provided by the wireless infrastructure 300. A 3^{rd} party instant messaging service is also shown that utilizes a 3^{rd} party instant messaging server 308 accessed by mobile device 10A through the wireless network 20. As can be seen, the 3^{rd} party instant messaging server 308 may also communicate with desktop computers 18 thus facilitating instant messaging between desktop computers 18 and between a mobile device 10 and a desktop application on a desktop computer 18. Similarly, the peer-to-peer based messaging system may also facilitate communications with desktop computers 18.

In the embodiment illustrated in FIG. 3, a PIN-based messaging system is implemented using a server-based communication infrastructure, such as one that provides email, SMS, voice, Internet and other communications. Particularly suitable for hosting a peer-to-peer messaging server 302, is a wireless router or server used in systems such as those that provide push-based communication services. In FIG. 3, the wireless infrastructure 300 facilitates communications such as instant messaging between mobile device 10A and mobile devices for User B, User C and User D, denoted by 10B, 10C and 10D respectively using a peer-to-peer messaging server 302. It will be appreciated that the number of users participating in the example shown in FIG. 3 is for illustrative purposes only. Instant messaging is provided by an instant messaging program or application stored on each mobile device 10A-10D which can be initiated, for example, by highlighting and selecting an instant messaging icon from a display as is well known in the art. The peer-to-peer messaging server 302 routes messages between the mobile devices 10A-10D according to an IM protocol 304.

An instant message is generally denoted by numeral 314 in FIG. 3, and has a format that is particularly suitable for a PIN-to-PIN based system. In a typical IM protocol 304, each message 314 has associated therewith a source corresponding to the mobile device 10 which has sent the message 314 and includes a destination identifying the intended recipient. Further detail of an example structure for the messages 314 is also shown in FIG. 3. Each message 314 generally comprises a body 328, which contains the content for the message 314 (e.g. text), and a header 316, which contains various fields used for transmitting and processing each message 314. In this example, the header 316 includes a message type field 318 to specify the type of transmission (e.g. PIN, SMS etc.), a source field 320 to specify the device address for the sender, a destination field 322 to specify the device address for the intended recipient, a conversation ID field 324 to identify which conversation thread the message 314 corresponds to (e.g. such that each message 314 is identified by the conversation in which it was sent), and a timestamp field 326 to indicate the time (and if desired, the date) at which the message 314 was sent by the designated sender.

It will be appreciated that other information or attributes may be included in the message 314, such as a subject field (not shown) to enable a subject for part or all of the conversation to be transported with the message 314 (e.g. to create new subjects, modify subjects, notify others of subjects, etc.). Although not shown in FIG. 3, one or more tags can also be used to indicate to the instant messaging application 22, upon receipt of a message 314, that the message 314 has certain attributes such as a subject that is to be displayed, whether additional information is being transported (i.e. data or information in addition to the message content), or whether the message 314 is being used for some other purpose such as provisioning, synchronization, etc.

In general, in an IM protocol 304, the sender of the message 314 knows the source address of the intended recipient, e.g. a PIN. This may be established when the two devices request to add each other to their respective contact or buddy lists. At the time of requesting new contacts, in traditional IM protocols 304, the two respective PIN numbers may be exchanged via request e-mails which are configured to be intercepted by the respective instant messaging applications 22 so as to not appear in the message list or “inbox” of the user. In other embodiments, to avoid the exchange of email messages to add a buddy to the IM contact list 18, a global address list (GAL) application (at the host system—not shown) may instead be accessed in order to obtain the source address for the intended recipient directly. Alternatively, the user may simply ask for the source address from another user and enter it manually.

It can be seen in the example shown in FIG. 3 that mobile device 10A can communicate directly with any of the mobile devices 10B-10D through the peer-to-peer messaging server 302 as indicated by the short-dashed line. Instant messaging can also be accomplished through the 3^{rd} party IM server 308 by sending 3^{rd} party based instant messages 312 over the wireless network 20 as indicated by the long-dashed line.

When conducting an instant messaging session according to the embodiment shown in FIG. 3, the mobile devices 10A-10D can communicate directly with the wireless infrastructure 300 in a client based exchange where, similar to other peer-to-peer programs, an intermediate server is not required. A message 314 sent by one mobile device 10 is received by the wireless infrastructure 300, which obtains the source address for the intended recipient from information associated with the message 314 (e.g. a data log) or from the message 314 itself. Upon obtaining the recipient's address according to the IM protocol 304, the wireless infrastructure 300 then routes the message 314 to the recipient associated with the mobile device 10 having such address. The wireless infrastructure 300 typically also provides a delivery confirmation to the original sender, which may or may not be displayed to the user. The destination device can also provide such delivery information. The wireless infrastructure 300 should be capable of routing messages 314 reliably and hold onto the messages 314 until they are successfully delivered. Alternatively, if delivery cannot be made after a certain timeout period, the wireless infrastructure 300 may provide a response indicating a failed delivery. The wireless infrastructure 300 may choose to expire a message 314 if a certain waiting period lapses.

It will also be appreciated that, as noted above, instant messaging can be implemented using any other suitable protocol such as SMS (not shown). In an SMS system, a message is transmitted to an SMC center (SMSC) within a carrier's infrastructure, and then delivered to the mobile phone number of the destination device (mobile devices 10A, 10B, 10C, or 10D in this example). The SMSC would also be configured to hold onto messages by storing them in a message storage memory and deliver then once the destination device is within coverage of the wireless network 20.

Turning back to FIG. 3, when conducting an instant messaging session using a 3^{rd} party IM application, access to the 3^{rd} party IM server 308 is first established and instant messages 312 are exchanged over the wireless network 20 according to the appropriate protocol used by the 3^{rd} party. It will be appreciated that the principles discussed below are equally applicable to both peer-to-peer (e.g. PIN-to-PIN) messaging and other Internet service-based instant messaging systems hosted by such 3^{rd} parties.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device 10, wireless infrastructure 34, peer-to-peer messaging server 80, 3^{rd} Party IM server 86, desktop computer 18, server 12, etc., or accessible or connectable thereto. Any application or module herein described may be implemented using computer readable/executable instructions that may be stored or otherwise held by such computer readable media.

FIG. 4 illustrates an external view of an example mobile device 10. The mobile device 10 includes, among other things, a display 36, which provides a display screen 38. An uppermost portion of the display screen 38 may be referred to as the ribbon 40 as discussed above. Also shown on the display screen 38 in this example is a series of icons 42, the icons 42 each corresponding to a particular application 16 such that selection of an icon 42 initiates and displays a respective application 16 on the display screen 38.

FIG. 5 illustrates a screen shot 44 showing an example ribbon 40. In this example, the ribbon 40 comprises various radio/connectivity icons 45 in an upper leftmost corner, a battery icon 46 indicative of remaining battery lift in an upper rightmost corner, a profiles icon 47 which, when selected enables a short-cut to a list of profiles (not shown) in the lower leftmost corner, and time/date information 48 displayed in a central portion of the ribbon 40. Also shown in FIG. 5 are an email notification icon 49, an SMS notification icon 50, a telephone notification icon 51, and a calendar notification icon 52. The icons 49, 50, 51,52 are displayed in response to particular event notifications 26. As shown in FIG. 5, each icon 49, 50, 51,52 may include a numeric indication of the number of unread events, as well as an asterisk to indicate whether or not the new events have been viewed or acknowledged. For example, at this particular point in time, 3 unread emails reside in an email application or inbox and the asterisk indicates that at least one of these unread emails has not yet been viewed. If the user were to access the inbox, the asterisk would be removed indicating that the unread emails have been viewed if not opened.

An instant messaging (IM) notification icon 53 is also shown in FIG. 4. As discussed above, although such an icon 53 may indicate that a particular number of messages or events are unread and whether or not at least one has not been viewed, the icon 53 is generic in that it does not convey when specific contacts and/or groups of contacts correspond to the events detected. To address this potential drawback and to provide more context regarding events related to the IM application 22, in addition to the IM notification icon 53 (or instead of—not shown), a series of personal visual notification icons 54 and a series of group visual notification icons 55 may be displayed in the ribbon 40 in association with the IM notification icon 53. In this way, the user can not only be notified of new events, but for IM and group related activities the origin of the event may be indicated to provide further context. Since IM and group contacts are typically “close” contacts that the user may be more inclined to be immediately responsive to, providing particular icons 54, 55 in the ribbon 40 enhances this experience.

It can be appreciated that the icons 54, 55 may be any available visual identifier that enables one to distinguish a particular contact or group from another. For example, avatars can be used for the personal icons 54 and group graphics or logos used for the group icons 54.

As discussed above, since the mobile device 10 may store and utilize many different contacts, including both personal and group contact list entries, the way in which particular icons 54, 55 are selected and displayed can be controlled according to user selectable preferences.

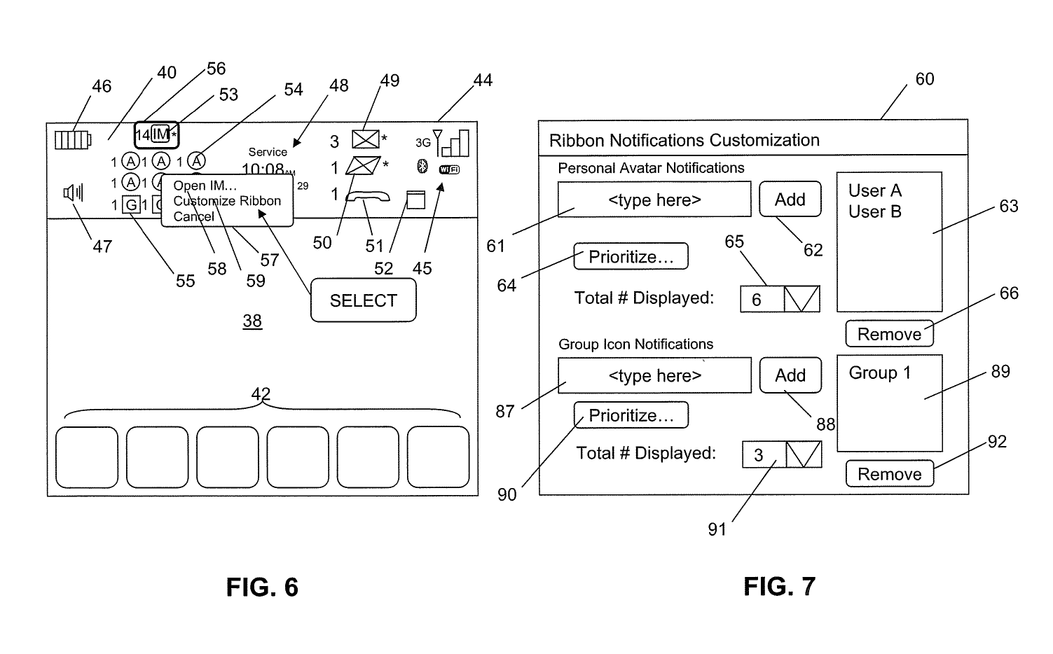

Turning now to FIG. 6, in this example, by using a suitable input or positioning device a menu 57 may be initiated and displayed in association with the ribbon 40. In this example, by highlighting the IM icon 53 using a bounding box 56 and selecting a menu or input button, the menu 57 is displayed. The menu 57 comprises an open IM option 58, a customize ribbon option 59, and an option to cancel or otherwise close the menu 57. As illustrated in FIG. 6, by selecting the customize ribbon option 59, a ribbon notification customization interface 60 is initiated and displayed as shown in FIG. 7.

Referring now to FIG. 7, a first entry box 61 enables particular personal contacts to be entered or otherwise selected (e.g. via a lookup function etc.) to be added to a first list of contacts 63 which indicates those personal contacts that will be indicated in the ribbon 54 when an event associated therewith is received or obtained. A first add button 62 is selected once the contact has been identified in the entry box 61 and a first remove button 66 can be used to remove a highlighted contact from the first list of contacts 63. For those contacts in the first list of contacts 63, a priority level or designation may be given by selecting a prioritize button 64. By selecting the prioritize button 64 a selection mechanism (not shown) may be displayed to assign a priority level to a particular contact. It can be appreciated that various selection mechanisms can be used and any number of priority levels can be used. For example, high and low priority designations can be used to sort important contacts from casual contacts. To allow the user to further customize their ribbon 40 a total number displayed pull down tool 65 is provided. In this way, if the user only has a few important contacts, they can minimize the number of icons 54 shown in the ribbon 40 at any given time. For example, if a user has many contacts but only two are important enough to warrant room on the ribbon 40 (e.g. User A and User B), the tool 65 can be used to limit the number of icons 54 to two.

Similar options are provided for designating group contacts. A second entry box 87, second add button 88, second list of contacts 89, and second remove button 92 enables group contacts (i.e. a contact list entry associated with a group of contacts) to be added to the second list of contacts 89 thus indicating which group icons 55 will be displayed in the ribbon 40 when new events originating or associated with those groups are received or obtained. As for personal icons 54, a total number displayed tool 91 can be used to indicate how many group icons 55 can be displayed at the same time. By providing separate tools 65, 91 for controlling the number of personal and group icons 54, 55 being displayed respectively, the user can selectively control not only the total number of icons 54, 55 being displayed but also the balance between the two types of icons 54, 55.

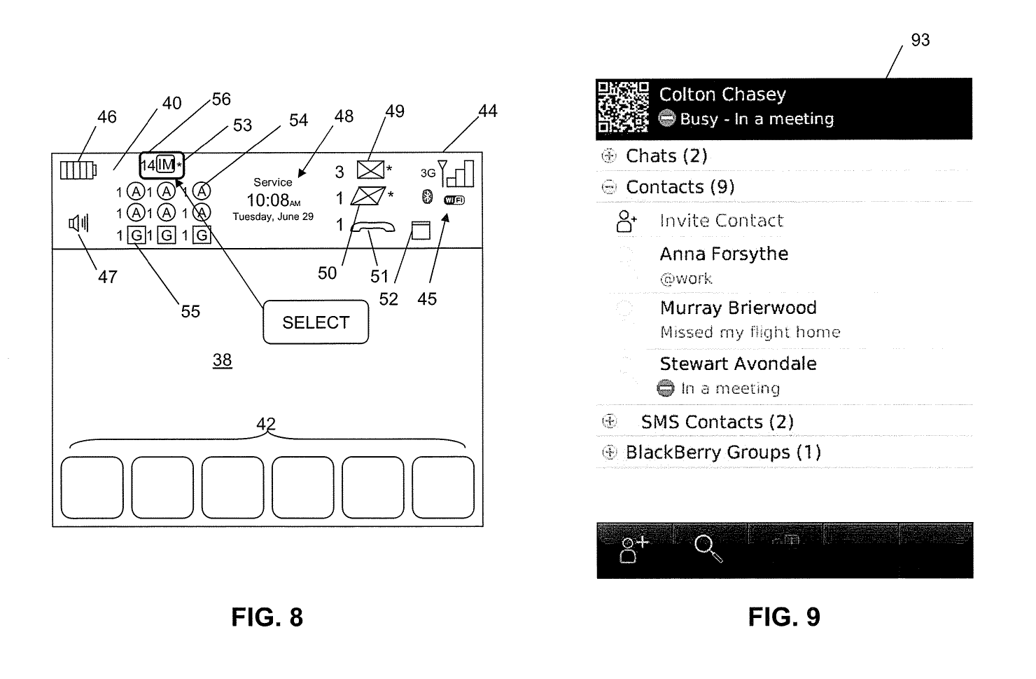

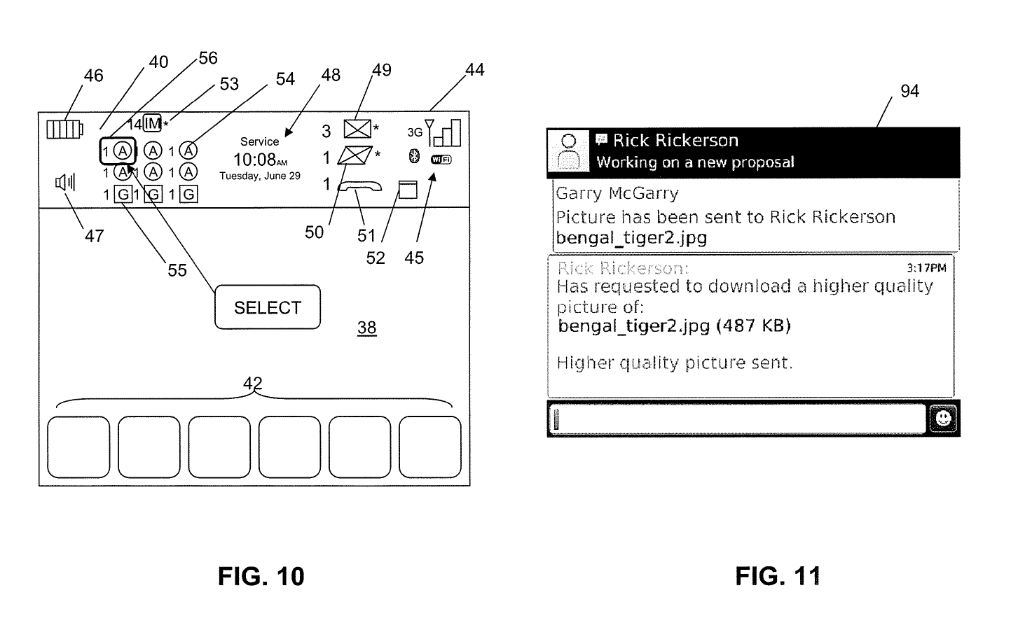

The provision of both an IM icon 53 and personal and group icons 54, 55, selection of particular ones of the icons 53, 54, 55 can also enable short-cut access to particular areas of the IM application 22. For example, as shown in FIG. 8, by highlighting and selecting the IM icon 53 (i.e. rather than invoking the menu 57 using, for example, a menu button), contact list interface 93 can be immediately initiated and displayed as shown in FIG. 9. Similarly, by highlighting and selecting a particular personal or group icon 54, 55 as shown in FIG. 10, the event associated with the event notification 26 (and thus icon 54) may be immediately initiated and displayed as shown in FIG. 11, wherein the receipt of a new picture in a conversation screen 94 is shown. Therefore, it can be appreciated that in addition to providing contextual information to the user at a glance, the icons 53, 54, 55 can be used as short-cuts to particular areas of the IM application 22 to further enhance the experience associated with the IM application 22, which is typically used to communicate with a more intimate circle of contacts.

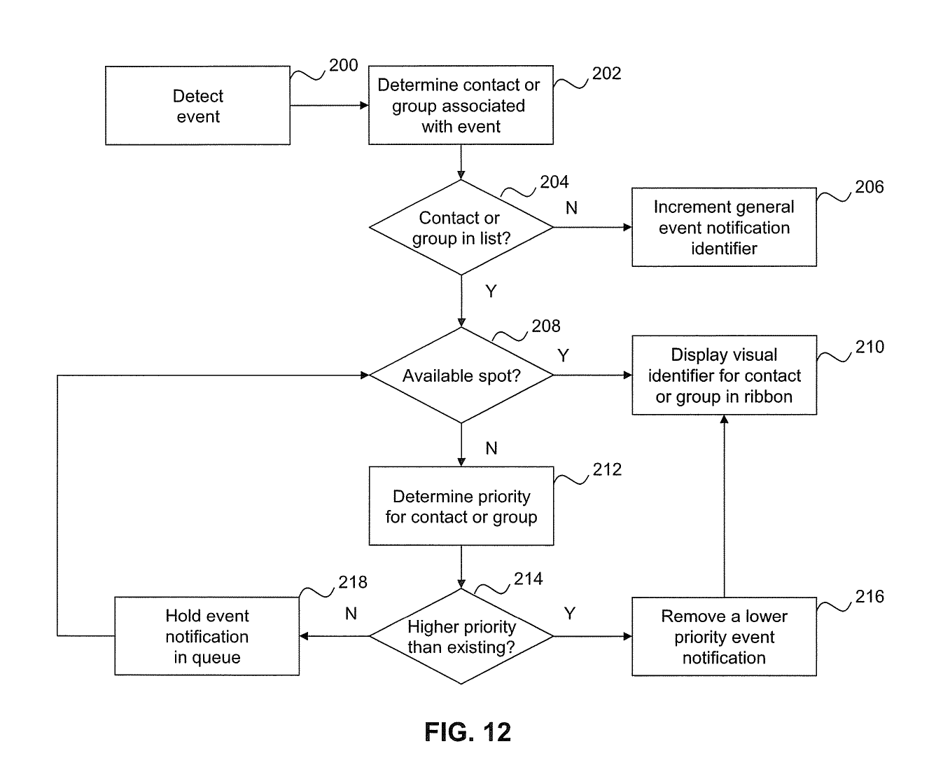

Turning now to FIG. 12, a flow chart is provided, illustrating an example set of computer executable instructions for controlling the display of the personal icons 54 and group icons 55. At 200 an event is detected. For example, a new instant message, multimedia file or other data 14 is received by the IM application 22. At 202, the IM application 22 determines the contact or group associated with the event and at 204 determines if the contact or group is in the first or second contact lists 63, 89. If not, the numeric counter associated with the IM icon 53 in this example is incremented at 206. If the contact or group associated with the event is in one of the first and second contact lists 63, 89, the IM application 22 then determines at 208 if there is/are any available spots in the ribbon 40. For example, if the user has designated only 3 spots for personal icons 54 and all three are filled, the determination at 208 would be “No”. However, if there are unused spots on the ribbon 40, then the visual identifier (personal or group icon 54, 55) for that contact or group is displayed in the ribbon 40 at 210. If there are no unused spaces, the IM application 22 may then determine the priority of the contact or group with respect to those currently displayed at 212. If at 214, the IM application 22 determines that the contact or group has a higher priority than at least one of the currently displayed contacts, a lower priority icon 54, 55 is removed at 216 and the icon 54, 55 for that particular contact or group is displayed at 210. If however, the currently displayed icons 54, 55 correspond to higher priority contacts, then the event notification 26 is recorded or otherwise held in a queue at 218 until there is space for it. The process then returns to 208 to repeat the determinations to enable the icon 54, 55 to be slotted in.

The determination and comparison of priorities can work in several ways depending on the application. For example, with a two tiered priority scale, low priority contacts would not be displayed in the ribbon individually unless or until events related to high priority contacts have been read or viewed and their icons 54, 55 removed. For contacts of the same priority level, a first-in, first-out approach can be used to push older event notification 26 off of the ribbon 40, or a timer could be referenced to ensure that a particular icon 54, 55 is given a predetermined amount of display time in the ribbon 40. To enable a greater number of icons 54, 55 to move into and out of the ribbon 40, once the events associated with the icons 54, 55 are read or viewed (or even if simply acknowledged), the icon 54, 55 could be removed. By also including the IM icon 53, those contacts or groups that are not in the lists 63, 89, as well as overall totals and general context may still be given. For example, if the counter associated with the IM icon 53 becomes quite large, the user may decide to access the IM application 22 to catch up on new events, regardless of context. It can be appreciated however that the IM icon 53 is optional and can be included or not according to the application or user preferences.

Additional intelligence could also be built into the process shown in FIG. 12. For example, if the user has selected that 6 spots be reserved for personal contacts and only 3 for groups as shown in these examples, but over time the IM application 22 detects that they more often communicate via the groups, the IM application 22 could adapt the balance of icons 54, 55 in the ribbon 40 to correspond to the user's actual activity at a particular time. This would then free up more space for event notifications more likely to be frequent and avoid holding space in the ribbon 40 that does not or rarely gets utilized.

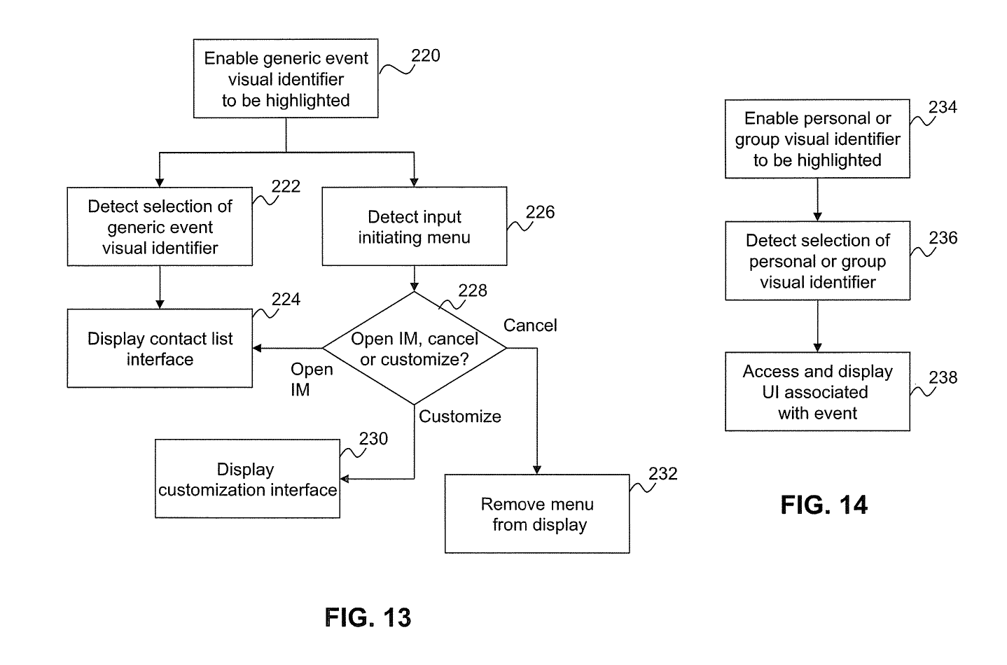

Turning now to FIG. 13, a flow chart is provided, illustrating an example set of computer executable instructions for controlling the short-cut access to the IM application 22 and customization interface 60 using the icon 53 and menu 57. At 220, the display module 28 enables the IM icon 53 to be highlighted, e.g. using the bounding box 56. If the display module 28 detects the selection of the IM icon 53 at 222, as shown in FIG. 8, the IM UI, in this example the contact list interface 93 is displayed at 224. If the display module 28 detects an input initiating the menu 57 at 226, the display module 28 then determine the next input at 228. If the display module 28 detects selection of the open IM option 58, the IM UI is displayed at 224. If the cancel option is detected, the menu 57 is removed from the display screen 38 at 232. If the customize ribbon option 59 is selected, the customization interface 60 is displayed at 230.

Turning now to FIG. 14, a flow chart is provided, illustrating an example set of computer executable instructions for controlling the short-cut access to the event associated with the icons 54, 55. At 234, the display module 28 enables a desired one of the icons 54, 55 to be highlighted, e.g. using the bounding box 56. Upon detecting selection of an icon 54, 55 at 236, the display module 28 then accesses and displays the interface associated with the event at 238. For example, as shown in FIGS. 10 and 11, by selecting a particular personal icon 54, the conversation interface 94 wherein a new picture is received is then displayed.

It can therefore be seen that by using visually distinguishable identifiers that are already associated with particular contacts or groups of contacts, the mobile device 10 can use such identifiers and selectively associate them with event notifications displayed in the ribbon. In this way, the user can, at a glance, not only be notified of a new event, but also determine the origin of the event notification to provide better context for determining whether or not they wish to access and view the new event or update or whether this can be deferred.

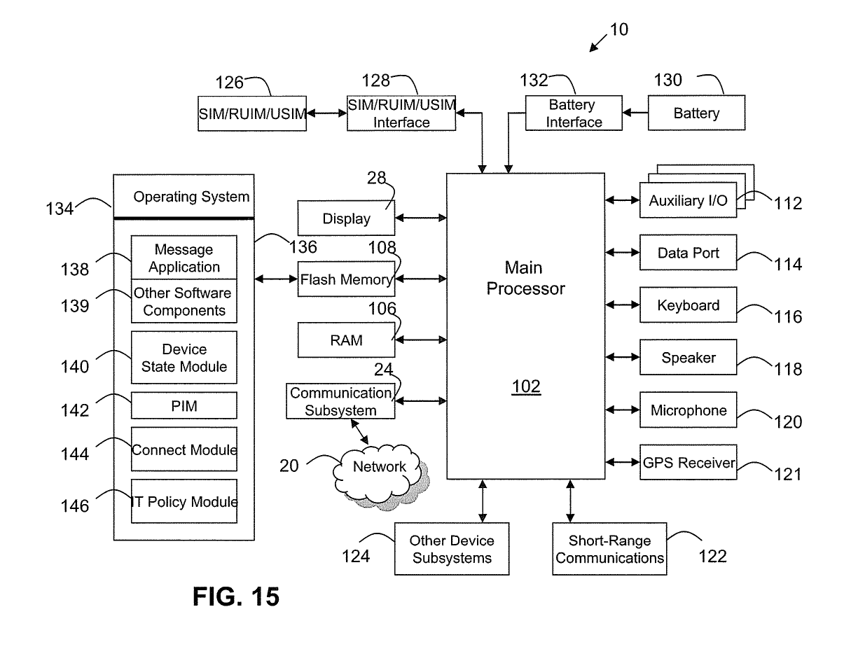

Referring now to FIG. 15, shown therein is a block diagram of an exemplary embodiment of a mobile device 10. The mobile device 10 comprises a number of components such as a main processor 102 that controls the overall operation of the mobile device 10. Communication functions, including data and voice communications, are performed through a communication subsystem 24. The communication subsystem 24 receives messages from and sends messages to a wireless network 20. In this example embodiment of the mobile device 10, the communication subsystem 24 is configured in accordance with the Global System for Mobile Communication (GSM) and General Packet Radio Services (GPRS) standards. The GSM/GPRS wireless network is used worldwide and it is expected that these standards will be superseded eventually by 3G and 4G networks such as EDGE, UMTS and HSDPA, LTE, Wi-Max etc. New standards are still being defined, but it is believed that they will have similarities to the network behaviour described herein, and it will also be understood by persons skilled in the art that the embodiments described herein are intended to use any other suitable standards that are developed in the future. The wireless link connecting the communication subsystem 24 with the wireless network 20 represents one or more different Radio Frequency (RF) channels, operating according to defined protocols specified for GSM/GPRS communications. With newer network protocols, these channels are capable of supporting both circuit switched voice communications and packet switched data communications.

The main processor 102 also interacts with additional subsystems such as a Random Access Memory (RAM) 106, a flash memory 108, a display 28, an auxiliary input/output (I/O) subsystem 112, a data port 114, a keyboard 116, a speaker 118, a microphone 120, GPS receiver 121, short-range communications 122 and other device subsystems 124.

Some of the subsystems of the mobile device 10 perform communication-related functions, whereas other subsystems may provide “resident” or on-device functions. By way of example, the display 28 and the keyboard 116 may be used for both communication-related functions, such as entering a text message for transmission over the network 20, and device-resident functions such as a calculator or task list.

The mobile device 10 can send and receive communication signals over the wireless network 20 after required network registration or activation procedures have been completed. Network access is associated with a subscriber or user of the mobile device 10. To identify a subscriber, the mobile device 10 may use a subscriber module. Examples of such subscriber modules include a Subscriber Identity Module (SIM) developed for GSM networks, a Removable User Identity Module (RUIM) developed for CDMA networks and a Universal Subscriber Identity Module (USIM) developed for 3G networks such as UMTS. In the example shown, a SIM/RUIM/USIM 126 is to be inserted into a SIM/RUIM/USIM interface 128 in order to communicate with a network. The SIM/RUIM/USIM component 126 is one type of a conventional “smart card” that can be used to identify a subscriber of the mobile device 10 and to personalize the mobile device 10, among other things. Without the component 126, the mobile device 10 may not be fully operational for communication with the wireless network 20. By inserting the SIM/RUIM/USIM 126 into the SIM/RUIM/USIM interface 128, a subscriber can access all subscribed services. Services may include: web browsing and messaging such as e-mail, voice mail, SMS, and MMS. More advanced services may include: point of sale, field service and sales force automation. The SIM/RUIM/USIM 126 includes a processor and memory for storing information. Once the SIM/RUIM/USIM 126 is inserted into the SIM/RUIM/USIM interface 128, it is coupled to the main processor 102. In order to identify the subscriber, the SIM/RUIM/USIM 126 can include some user parameters such as an International Mobile Subscriber Identity (IMSI). An advantage of using the SIM/RUIM/USIM 126 is that a subscriber is not necessarily bound by any single physical mobile device. The SIM/RUIM/USIM 126 may store additional subscriber information for a mobile device as well, including datebook (or calendar) information and recent call information. Alternatively, user identification information can also be programmed into the flash memory 108.

The mobile device 10 is typically a battery-powered device and includes a battery interface 132 for receiving one or more batteries 130 (typically rechargeable). In at least some embodiments, the battery 130 can be a smart battery with an embedded microprocessor. The battery interface 132 is coupled to a regulator (not shown), which assists the battery 130 in providing power V+ to the mobile device 10. Although current technology makes use of a battery, future technologies such as micro fuel cells may provide the power to the mobile device 10.

The mobile device 10 also includes an operating system 134 and software components 136 to 146 which are described in more detail below. The operating system 134 and the software components 136 to 146 that are executed by the main processor 102 are typically stored in a persistent store such as the flash memory 108, which may alternatively be a read-only memory (ROM) or similar storage element (not shown). Those skilled in the art will appreciate that portions of the operating system 134 and the software components 136 to 146, such as specific device applications, or parts thereof, may be temporarily loaded into a volatile store such as the RAM 106. Other software components can also be included, as is well known to those skilled in the art.

The subset of software applications 136 that control basic device operations, including data and voice communication applications, may be installed on the mobile device 10 during its manufacture. Other software applications include a message application 138 that can be any suitable software program that allows a user of the mobile device 10 to send and receive electronic messages. Various alternatives exist for the message application 138 as is well known to those skilled in the art. Messages that have been sent or received by the user are typically stored in the flash memory 108 of the mobile device 10 or some other suitable storage element in the mobile device 10. In at least some embodiments, some of the sent and received messages may be stored remotely from the mobile device 10 such as in a data store of an associated host system that the mobile device 10 communicates with.

The software applications can further comprise a device state module 140, a Personal Information Manager (PIM) 142, and other suitable modules (not shown). The device state module 140 provides persistence, i.e. the device state module 140 ensures that important device data is stored in persistent memory, such as the flash memory 108, so that the data is not lost when the mobile device 10 is turned off or loses power.

The PIM 142 includes functionality for organizing and managing data items of interest to the user, such as, but not limited to, e-mail, contacts, calendar events, voice mails, appointments, and task items. A PIM application has the ability to send and receive data items via the wireless network 20. PIM data items may be seamlessly integrated, synchronized, and updated via the wireless network 20 with the mobile device subscriber's corresponding data items stored and/or associated with a host computer system. This functionality creates a mirrored host computer on the mobile device 10 with respect to such items. This can be particularly advantageous when the host computer system is the mobile device subscriber's office computer system.

The mobile device 10 may also comprise a connect module 144, and an IT policy module 146. The connect module 144 implements the communication protocols that are required for the mobile device 10 to communicate with the wireless infrastructure and any host system, such as an enterprise system, that the mobile device 10 is authorized to interface with.

The connect module 144 includes a set of APIs that can be integrated with the mobile device 10 to allow the mobile device 10 to use any number of services associated with the enterprise system. The connect module 144 allows the mobile device 10 to establish an end-to-end secure, authenticated communication pipe with a host system (not shown). A subset of applications for which access is provided by the connect module 144 can be used to pass IT policy commands from the host system to the mobile device 10. This can be done in a wireless or wired manner. These instructions can then be passed to the IT policy module 146 to modify the configuration of the device 10. Alternatively, in some cases, the IT policy update can also be done over a wired connection.

The IT policy module 146 receives IT policy data that encodes the IT policy. The IT policy module 146 then ensures that the IT policy data is authenticated by the mobile device 100. The IT policy data can then be stored in the flash memory 106 in its native form. After the IT policy data is stored, a global notification can be sent by the IT policy module 146 to all of the applications residing on the mobile device 10. Applications for which the IT policy may be applicable then respond by reading the IT policy data to look for IT policy rules that are applicable.

Other types of software applications or components 139 can also be installed on the mobile device 10. These software applications 139 can be pre-installed applications (i.e. other than message application 138) or third party applications, which are added after the manufacture of the mobile device 10. Examples of third party applications include games, calculators, utilities, etc.

The additional applications 139 can be loaded onto the mobile device 10 through at least one of the wireless network 20, the auxiliary I/O subsystem 112, the data port 114, the short-range communications subsystem 122, or any other suitable device subsystem 124. This flexibility in application installation increases the functionality of the mobile device 10 and may provide enhanced on-device functions, communication-related functions, or both. For example, secure communication applications may enable electronic commerce functions and other such financial transactions to be performed using the mobile device 10.

The data port 114 enables a subscriber to set preferences through an external device or software application and extends the capabilities of the mobile device 10 by providing for information or software downloads to the mobile device 10 other than through a wireless communication network. The alternate download path may, for example, be used to load an encryption key onto the mobile device 10 through a direct and thus reliable and trusted connection to provide secure device communication.

The data port 114 can be any suitable port that enables data communication between the mobile device 10 and another computing device. The data port 114 can be a serial or a parallel port. In some instances, the data port 114 can be a USB port that includes data lines for data transfer and a supply line that can provide a charging current to charge the battery 130 of the mobile device 10.

The short-range communications subsystem 122 provides for communication between the mobile device 10 and different systems or devices, without the use of the wireless network 20. For example, the subsystem 122 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download may be processed by the communication subsystem 24 and input to the main processor 102. The main processor 102 may then process the received signal for output to the display 28 or alternatively to the auxiliary I/O subsystem 112. A subscriber may also compose data items, such as e-mail messages, for example, using the keyboard 116 in conjunction with the display 28 and possibly the auxiliary I/O subsystem 112. The auxiliary subsystem 112 may comprise devices such as: a touch screen, mouse, track ball, infrared fingerprint detector, or a roller wheel with dynamic button pressing capability. The keyboard 116 is an alphanumeric keyboard and/or telephone-type keypad. However, other types of keyboards may also be used. A composed item may be transmitted over the wireless network 20 through the communication subsystem 24.

For voice communications, the overall operation of the mobile device 10 in this example is substantially similar, except that the received signals are output to the speaker 118, and signals for transmission are generated by the microphone 120. Alternative voice or audio I/O subsystems, such as a voice message recording subsystem, can also be implemented on the mobile device 10. Although voice or audio signal output is accomplished primarily through the speaker 118, the display 28 can also be used to provide additional information such as the identity of a calling party, duration of a voice call, or other voice call related information.

Although the above has been described with reference to certain specific embodiments, various modifications thereof will be apparent to those skilled in the art without departing from the scope of the claims appended hereto.

1. A method of operating a mobile device, the method comprising:
obtaining a visual identifier indicative of a contact associated with an event; and
displaying the visual identifier in a ribbon portion of a display of the mobile device.

2. The method according to claim 1, wherein the contact is associated with an individual user, an electronic group associated with one or more user, or an entity represented by a contact list entry.

3. The method according to claim 1, further comprising:
determining that the event has been at least one of viewed and acknowledged; and
removing the visual identifier from the ribbon.

4. The method according to claim 1, further comprising:
detecting selection of the visual identifier; and
displaying an interface comprising data associated with the event.

5. The method according to claim 1 further comprising:
enabling one or more contacts to be added to one or more contact lists; and
determining if the contact associated with the event corresponds to a contact in the one or more contact lists.

6. The method according to claim 1, wherein a plurality of spaces are allocated in the ribbon for displaying a plurality of visual identifiers.

7. The method according to claim 6, further comprising:
determining if one of the plurality of spaces is available;
if a space is available, performing the displaying; and
if no spaces are available, enabling the visual identifier to be displayed at a later time if a space becomes available.

8. The method according to claim 6, further comprising:
enabling a priority to be allocated to each of the plurality of visual identifiers; and
performing the displaying according to the priorities.

9. The method according to claim 8, wherein higher priority visual identifiers displace lower priority visual identifiers if no spaces are available.

10. The method according to claim 1, further comprising displaying a generic visual identifier for displaying a total number of new events associated with an application utilizing contacts.

11. A computer readable medium comprising computer executable instructions for operating a mobile device, the computer executable instructions comprising instructions for:
obtaining a visual identifier indicative of a contact associated with an event; and
displaying the visual identifier in a ribbon portion of a display of the mobile device.

12. The computer readable medium according to claim 11, wherein the contact is associated with an individual user, an electronic group associated with one or more user, or an entity represented by a contact list entry.

13. The computer readable medium according to claim 11, further comprising instructions for:
determining that the event has been viewed or acknowledged; and
removing the visual identifier from the ribbon.

14. The computer readable medium according to claim 11, further comprising instructions for:
detecting selection of the visual identifier; and
displaying an interface comprising data associated with the event.

15. The computer readable medium according to claim 11, further comprising instructions for:
enabling one or more contacts or groups to be added to one or more contact lists; and
determining if the contact associated with the event corresponds to a contact in the one or more contact lists.

16. The computer readable medium according to claim 11, wherein a plurality of spaces are allocated in the ribbon for displaying a plurality of visual identifiers.

17. The computer readable medium according to claim 16, further comprising instructions for:
determining if one of the plurality of spaces is available;
if a space is available, performing the displaying; and
if no spaces are available, enabling the visual identifier to be displayed at a later time if a space becomes available.

18. The computer readable medium according to claim 16, further comprising instructions for:
enabling a priority to be allocated to each of the plurality of visual identifiers; and
performing the displaying according to the priorities.

19. The computer readable medium according to claim 18, wherein higher priority visual identifiers displace lower priority visual identifiers if no spaces are available.

20. The computer readable medium according to claim 11, further comprising instructions for displaying a generic visual identifier for displaying a total number of new events associated with an application utilizing contacts.

21. A mobile device comprising a processor and memory, the memory comprising computer executable instructions that when executed by the processor, operate the mobile device by:
obtaining a visual identifier indicative of a contact associated with an event; and
displaying the visual identifier in a ribbon portion of a display of the mobile device.

22. The mobile device according to claim 21, wherein the contact is associated with an individual user, an electronic group associated with one or more user, or an entity represented by a contact list entry.

23. The mobile device according to claim 21, further comprising instructions for:
determining that the event has been viewed or acknowledged; and
removing the visual identifier from the ribbon.

24. The mobile device according to claim 21, further comprising instructions for:
detecting selection of the visual identifier; and
displaying an interface comprising data associated with the event.

25. The mobile device according to claim 21, further comprising instructions for:
enabling one or more contacts to be added to one or more contact lists;
and determining if the contact associated with the event corresponds to a contact in the one or more contact lists.

26. The mobile device according to claim 21, wherein a plurality of spaces are allocated in the ribbon for displaying a plurality of visual identifiers.

27. The mobile device according to claim 26, further comprising instructions for:
determining if one of the plurality of spaces is available;
if a space is available, performing the displaying; and
if no spaces are available, enabling the visual identifier to be displayed at a later time if a space becomes available.

28. The mobile device according to claim 26, further comprising instructions for:
enabling a priority to be allocated to each of the plurality of visual identifiers; and
performing the displaying according to the priorities.

29. The mobile device according to claim 28, wherein higher priority visual identifiers displace lower priority visual identifiers if no spaces are available.

30. The mobile device according to claim 21, further comprising instructions for displaying a generic visual identifier for displaying a total number of new events associated with an application utilizing contacts.
